(19) United States
(12) Patent Application Publication
(10) Pub. No.: US 2009/0271811 A1
(43) Pub. Date: Oct. 29, 2009

(54) RECORDING APPARATUS

(75) Inventors: Shintaro KOMURO, Shiojiri-shi (JP); Narihiro OKI, Matsumoto-shi (JP); Kazumasa HARADA, Matsumoto-shi (JP); Satoshi YOSHINO, Shiojiri-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/426,627

(22) Filed: Apr. 20, 2009

(30) Foreign Application Priority Data
Apr. 23, 2008 (JP) 2008-112199

(51) Int. Cl. G11B 17/03

(52) U.S. Cl. 720/601; G9B/17.009

(57) ABSTRACT

A recording apparatus includes a transport roller that transports recording materials, a holding tray for setting a first recording material, which is configured to be advanced and retracted between a first position wherein the first recording material can be transported by the transport roller and a second position wherein the holding tray is retracted from the first position, and a path forming member for guiding a second recording material from above or below the second position to a position wherein the recording material can be transported by the transport roller, in which a front end portion of the holding tray being retracted to the second position protrudes to a position located between a guide path formed by the path forming member and the transport roller.

### BACKGROUND

1. Technical Field

The present invention relates to a recording apparatus which is typified by a printer, a facsimile, or a copier, and which includes a path forming member that guides a first recording material toward a transport roller, a holding tray for a second recording material stored at a storage position provided in a space portion extending along the path forming member, and the transport roller that is provided at a downstream position of the path forming member.

2. Related Art

An ink jet printer will be described as an example of a recording apparatus. Among ink jet printers, there is known a printer having a structure capable of selectively executing a recording operation on both a soft recording material without self-supporting properties such as paper or film and a hard recording material having self-supporting properties such as an optical disk (e.g., CD-R and DVD-R) (reference should be made to, for example, JP-A-2005-059584). The optical disk is transported in a state of being set on a special holding tray.

However, in the printer disclosed in JP-A-2005-059584, since a transport path of the soft recording material and a transport path of the hard recording material are configured to be independent from each other, the printer is likely to become bulky. Particularly, such a problem becomes prominent in a structure that incorporates the holding tray in the printer body.

### SUMMARY

An advantage of some aspects of the invention is that it provides a recording apparatus capable of incorporating therein a holding tray for holding a second recording material while maintaining the compactness of a recording apparatus main body.

According to a first aspect of the invention, there is provided a recording apparatus including a transport roller that transports recording materials; a holding tray for setting a first recording material, which is configured to be advanced and retracted between a first position wherein the first recording material can be transported by the transport roller and a second position wherein the holding tray is retracted from the first position; and a path forming member for guiding a second recording material from above or below the second position to a position wherein the recording material can be transported by the transport roller, in which a front end portion of the holding tray being retracted to the second position protrudes to a position located between a guide path formed by the path forming member and the transport roller.

According to this aspect of the invention, since at least a part of the front end portion of the holding tray is provided so as to protrude from the downstream end of the path forming member in a state of being positioned at the second position, a part of the front end portion of the holding tray being protruded from the downstream end of the path forming member can be used as a part of the transport path for the second recording material.

Moreover, the holding tray has a minimum depth dimension necessary for holding the first recording material. Therefore, although a depth dimension of the path forming member becomes large when the holding tray is completely stored in the space portion of the path forming member, it is possible to achieve the compactness of the path forming member by the arrangement that a part of the holding tray is protruded out from the downstream end of the path forming member.

A second aspect of the invention is the recording apparatus according to the first aspect, in which a pivotable upper guide flap configured to bury a step difference between the path forming member and the holding tray is provided at a downstream end of the path forming member in a retractable state wherein the movement of the holding tray is not inhibited.

According to this aspect of the invention, by providing the upper guide flap, it is possible to prevent the first recording material from being caught at the step difference between the path forming member and the holding tray when the first recording material is transported in the reverse direction, for example, in accordance with duplex printing or the like. Moreover, since the upper guide flap is configured to be pivotable and is provided in a retracted state wherein the movement of the holding tray is not inhibited, it is possible to maintain smooth movement of the holding tray. Furthermore, since a so-called “reverse” arrangement wherein the position of a driven transport roller in the transport direction is located slightly closer to the recording position than the position of a driving transport roller in the transport direction is employed in the step difference formed between the holding tray and the transport roller, the first recording material can be prevented from being caught at the step difference.

A third aspect of the invention is the recording apparatus according to the second aspect, in which pivotable lower guide flaps which are urged upwardly are provided between the holding tray and the transport roller so as to bury a step difference between them in a retractable state wherein the movement of the holding tray is not inhibited.

According to this aspect of the invention, by providing the lower guide flaps, it is possible to prevent the first recording material from being caught at the step difference between the holding tray and the transport roller when the first recording material is transported in the reverse direction, for example, in accordance with duplex printing or the like. Moreover, since the lower guide flaps are configured to be pivotable and are provided to be urged upwardly in a retracted state wherein the movement of the holding tray is not inhibited, the lower guide flaps are retracted downward during movement of the holding tray, thereby allowing the movement of the holding tray, while the lower guide flaps protrude upwardly during storage of the holding tray, thereby functioning as a transport guide member for the first recording material.

The function of the lower guide flaps can be realized by lengthening the upper guide flap so as to bury the step difference between the holding tray and the transport roller. However, when the upper guide flap is lengthened, the upper guide flap may make abutting contact with the transport guide member being provided in the upper vicinity thereof, so that the second recording material cannot be smoothly transported. To the contrary, since such a problem does not occur when both the upper guide flap and the lower guide flaps having a small acting length are used together as in the case of this aspect of the invention, both the first recording material and the second recording material can be smoothly transported.

A fourth aspect of the invention is the recording apparatus according to the third aspect, in which a comb-teeth shaped uneven surface structure on which convex portions and concave portions are continuously formed in an alternating manner is formed on the front end portion of the holding tray, in which the convex portions are configured as guide claws which protrude from the downstream end of the path forming member and the concave portions are configured as concave receipt portions which receive therein the lower guide flaps.

According to this aspect of the invention, owing to the guide claws formed on the front end portion of the holding tray, the first recording material can be smoothly transported from the path forming member to the transport roller. Moreover, owing to the concave receipt portions provided between the guide claws, the lower guide flaps can be provided at a closer position without interfering with the holding tray positioned at the storage position, and thus the first recording material can be more smoothly transported in the reverse direction.

A fifth aspect of the invention is the recording apparatus according to any one of the second to fourth aspects, in which a levitating projection portion is formed in a part of the upper guide flap so as to make sliding contact with an upper surface of the holding tray when the holding tray is moved from a storage position, thereby levitating the lower edge of the upper guide flap from the upper surface of the holding tray to be in a non-contact state.

According to this aspect of the invention, during movement of the holding tray, since the lower edge of the upper guide flap is in a non-contact state wherein it is levitated from the upper surface of the holding tray and the second recording material set on the holding tray, the holding tray can be smoothly transported without receiving large transport resistance from the upper guide flap. This is particularly advantageous because it is possible to effectively prevent the holding tray from being caught at the upper guide flap when the holding tray returns to the storage position from a state of being drawn out frontward.

A sixth aspect of the invention is the recording apparatus according to the fifth aspect, in which when the holding tray is positioned at the storage position, the levitating projection portion is received in a recessed portion, which is formed on the upper surface of the holding tray, to be in a non-contact state with the upper surface of the holding tray, and the lower edge of the upper guide flap is in a closed state wherein the step difference between the path forming member and the holding tray is buried.

According to this aspect of the invention, since the levitating projection portion is received in the recessed portion when the holding tray is positioned at the storage position, the lower edge of the upper guide flap falls downward, whereby the step difference between the path forming member and the holding tray is completely buried. Therefore, the first recording material is prevented from being caught at the step difference, and the first recording material can be smoothly transported.

According to a seventh aspect of the invention, there is provided a recording apparatus including a transport roller that transports recording materials; a holding tray for setting a first recording material, which is configured to be advanced and retracted between a first position wherein the first recording material can be transported by the transport roller and a second position wherein the holding tray is retracted from the first position; and a path forming member for guiding another recording material toward the transport roller, which forms a guide path at a position overlapping the second position in a vertical direction, in which a front end portion of the holding tray being retracted to the second position protrudes to a position located between the guide path and the transport roller.

### BRIEF DESCRIPTION OF THE DRAWINGS

The invention will be described with reference to the accompanying drawings, wherein like numbers reference like elements.

FIG. 1 is a perspective view showing an internal structure of an ink jet printer according to an embodiment of the invention.

FIG. 2 is a side sectional view of the ink jet printer when a holding tray is received therein.

FIG. 3 is a side sectional view of the ink jet printer at the start of execution of a previous recording operation.

FIG. 4 is a side sectional view of the ink jet printer at the end of execution of a previous recording operation.

FIG. 5 is a side sectional view of the ink jet printer when a second recording material is set thereon.

FIG. 6 is a perspective view showing portions of a path forming member from a downstream end thereof to a portion thereof being extended to a transport roller when the holding tray is positioned at a storage position.

FIG. 7 is a perspective view when the holding tray is moved from the storage position.

FIG. 8 is a side sectional view when the holding tray is positioned at a storage position.

FIG. 9 is a side sectional view when the holding tray is moved from the storage position.

FIG. 10 is an enlarged perspective view as seen from an oblique left side when the holding tray is moved from the storage position.

FIG. 11 is a top plan view when the holding tray is positioned at a storage position.

FIG. 12 is a top plan view of the holding tray at the start of execution of a previous recording operation.

FIG. 13 is a top plan view of the holding tray at the end of execution of a previous recording operation.

FIG. 14 is a top plan view of the holding tray when a second recording material is set thereon.

### DESCRIPTION OF EXEMPLARY EMBODIMENTS

Hereinafter, a recording apparatus according to an embodiment of the invention will be described. First, an ink jet printer 1 will now be described as a recording apparatus according to an exemplary embodiment of the invention and the schematic entire structure of the printer will be described below with reference to the drawings.

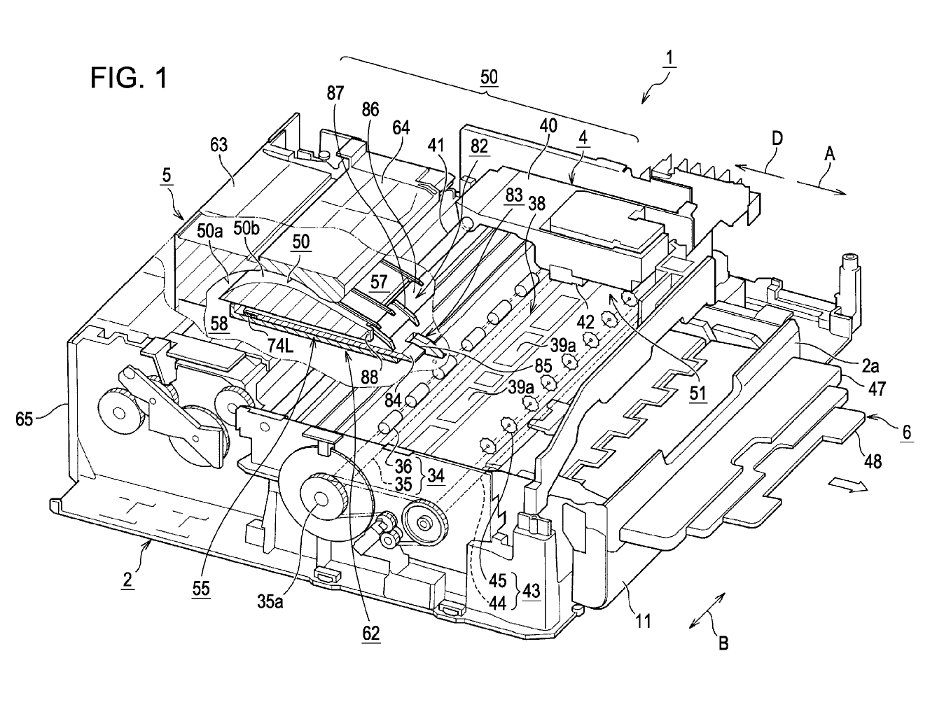

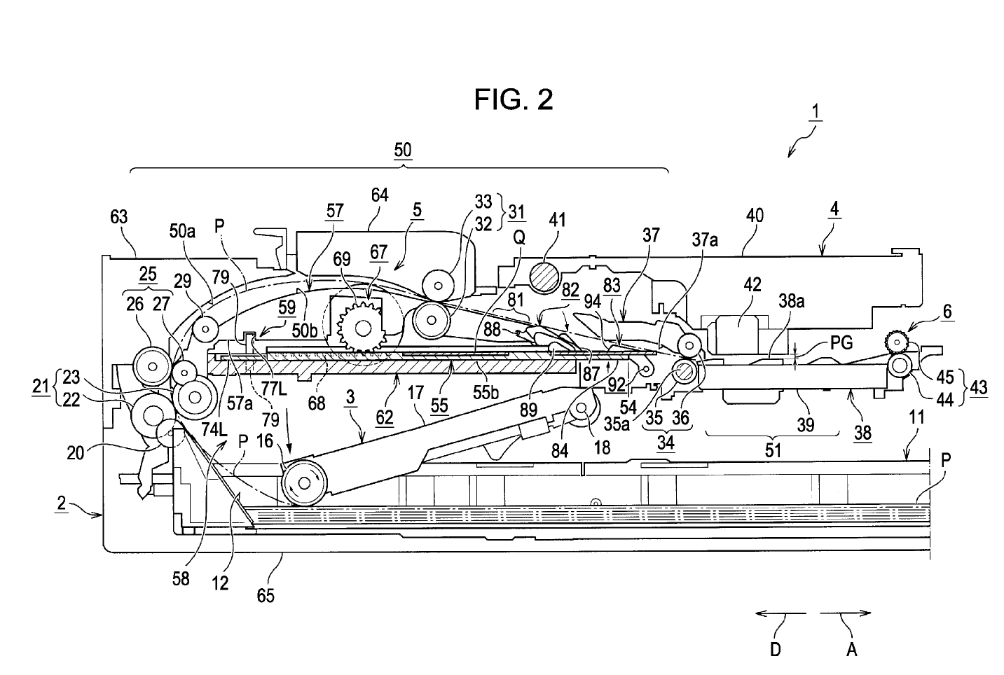

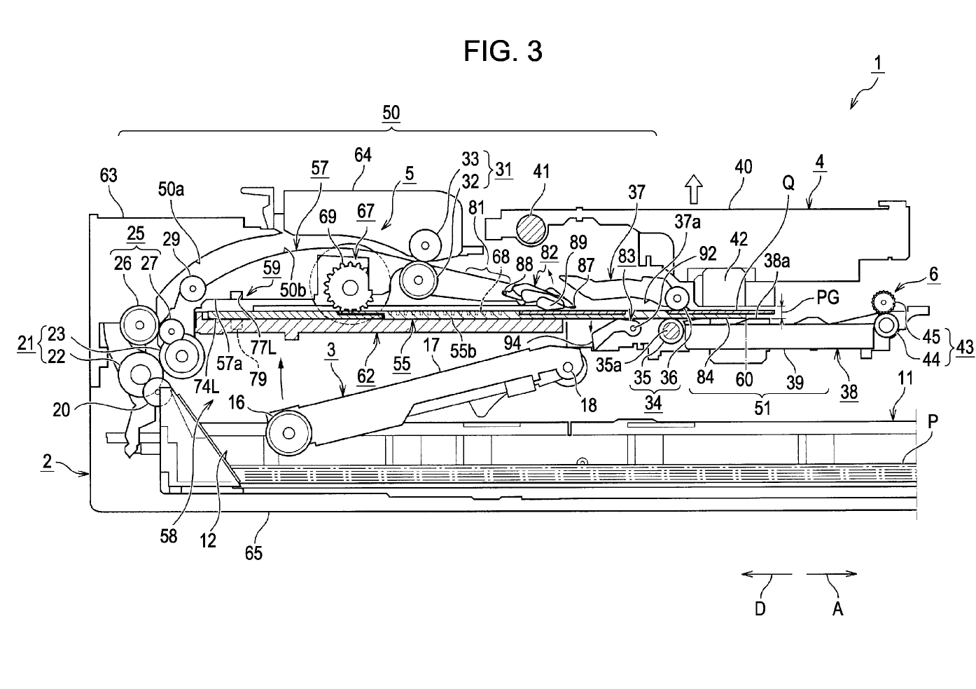

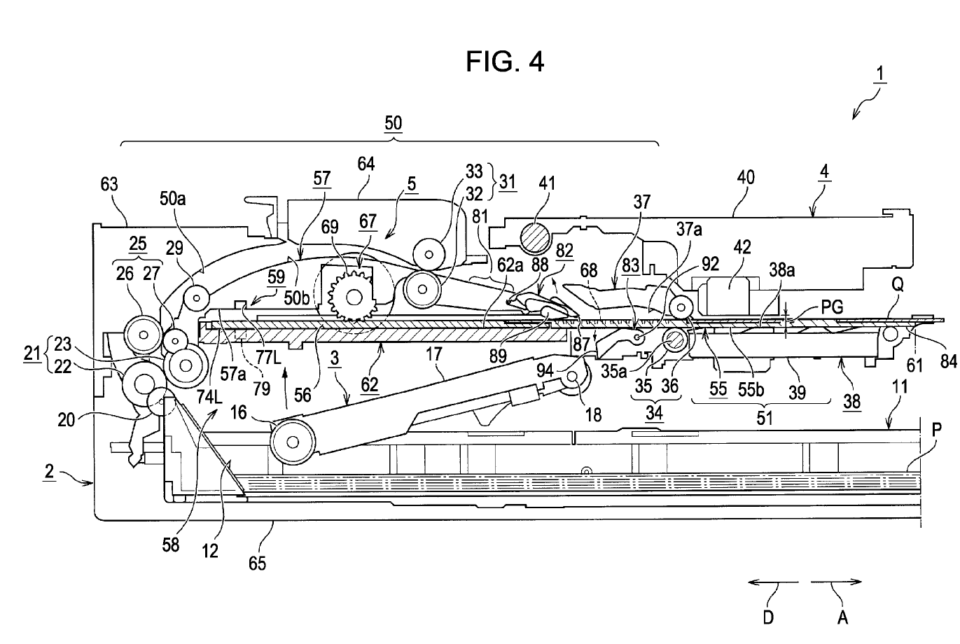

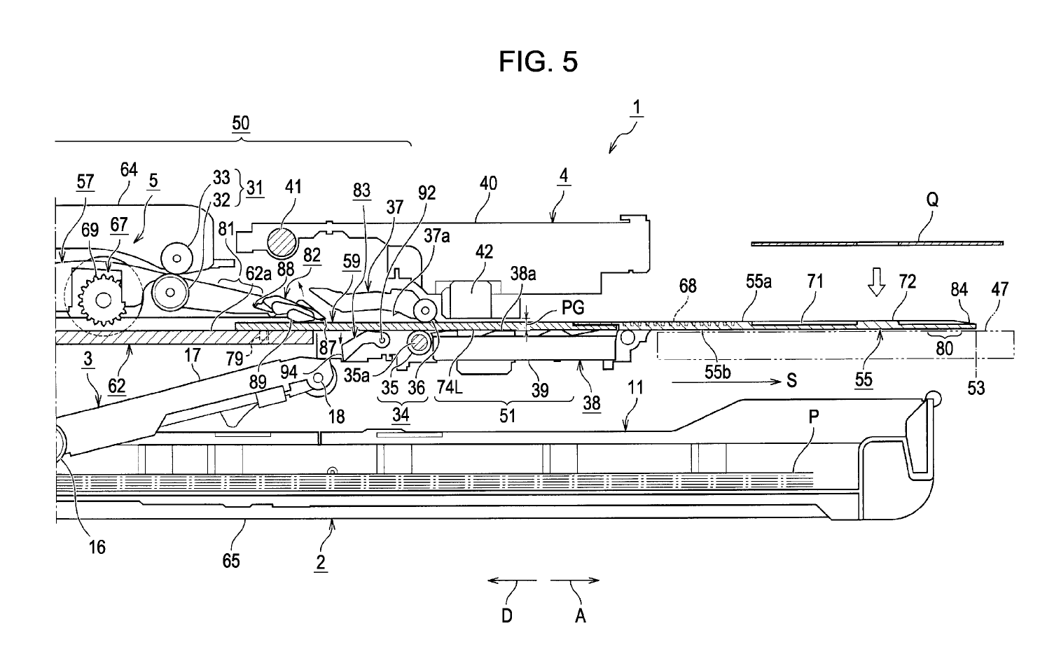

FIG. 1 is a perspective view showing an internal structure of an ink jet printer, and FIG. 2 is a side sectional view showing a schematic internal structure of the ink jet printer when a holding tray is positioned at a storage position thereof. FIG. 3 is a side sectional view of the ink jet printer when the holding tray is positioned at a recording execution start position thereof, and FIG. 4 is a side sectional view of the ink jet printer when the holding tray is positioned at a recording execution ending position thereof. FIG. 5 is a side sectional view of the ink jet printer when the holding tray is positioned at a set position thereof.

The ink jet printer 1 is a multi-functional ink jet printer, on which a not-shown image reading device (scanner) is mounted, and is a such a type of ink jet printer that is capable of executing a recording operation on both a first recording material P, which is a soft recording material such as sheet or film, and a second recording material Q which is a hard recording material such as an optical disk including CD-R and DVD-R. The ink jet printer 1 is a serial printer in which a recording head 42 is mounted on a lower surface of a carriage 40 which is capable of reciprocating along a width direction B intersecting a transport direction A, the lower surface corresponding to a recording execution region of the two kinds of first and second recording materials P and Q.

The ink jet printer 1 is provided with a printer body 2 which is a recording apparatus main body having a rectangular casing shape and has an external appearance configured by a relatively flat surface. Moreover, a feed cassette 11 capable of accommodating therein a number of first recording materials P in a stacked state is detachably attached to a central lower portion of a front surface 2a of the printer body 2. Furthermore, a discharge stacker 47 for stacking the first recording material P having data or images recorded thereon in a stacked state is provided above the mounting surface of the feed cassette 11. In addition, on the front surface 2a of the printer body 2, not-shown operation buttons for execution of various operation instructions, not-shown cartridge holders for receiving therein various ink cartridges, and the like are provided.

The feed cassette 11 is a member which is installed at a beginning position of the transport path of the first recording material P. The first recording materials P accommodated in the feed cassette 11 are sequentially and continuously fed out on a one-by-one basis from the uppermost one by an automatic feeding device 3 to be fed toward a later-described U-shaped reversal path 50. The automatic feeding device 3 is configured to include a pickup roller 16 that rearwardly draws an upper one of the first recording material P in the feed cassette 11, a sloped separation surface 12 that guides the upper one of the first recording material P, which is drawn rearward, to the U-shaped reversal path 50, while preliminarily separating the first recording material, a first guide roller 20 which is provided obliquely above a rear portion of the sloped separation surface 12 in a freely rotatable state, and a separation roller 21 which is provided obliquely above a rear portion of the first guide roller 20.

The pickup roller 16 is provided at a front end portion of a pivot arm 17 which pivots about a pivot shaft 18 so as to make pressure contact with an upper surface of the first recording material P during feeding thereof, whereby the upper one of the first recording material P in the feed cassette 11 is drawn rearward by its rotation in the transport direction A. The separation roller 21 is applied with a predetermined rotational resistance by a torque limiter mechanism and is configured by a pair of nip rollers of a driven separation roller 22 and a driving separation roller 23. The separation roller 21 performs a main separation operation that completely separates a subsequent one of the first recording material P, which was unable to separate in the preliminarily separation by the sloped separation surface 12, from the uppermost one of the first recording material P.

The first recording material P fed to the U-shaped reversal path 50 is transported on the U-shaped reversal path 50 by a later-described recording-material feeding device 5 according to the present embodiment to be guided to a recording position 51. Under the recording position 51, a platen 38 is provided which supports the lower surface of the first recording material P or the second recording material Q, which is transported thereto, to thereby define a gap PG between the recording material and the lower surface of the recording head 42. The platen 38 is configured to include a transport guide portion 39 which is a support member, platen ribs 38a which are formed on an upper surface of the transport guide portion 39, and ink recovery grooves 39a for recovering surplus ink which was not used for execution of a recording operation.

On the other hand, above the recording position 51, there are provided the recording head 42 which is a major constituent element of the recording execution device 4 which is a recording execution unit, and the carriage 40 which is capable of reciprocating while being guided in the width direction B along a carriage guide shaft 41 in a state of mounting the recording head 42 on a lower surface thereof. The recording execution device 4 is configured to include a plurality of not-shown, ink tubes and ink supply pumps for supplying ink of each color to the recording head 42, a not-shown capping device which is provided at the home position of the carriage 40, a not-shown automatic gap adjustment mechanism which is used, for example, when switching between the first recording material P and the second recording material Q, and the like. The recording head 42 is provided in the vicinity of a downstream position of a later-described transport roller 34.

At a downstream position of the recording position 51, a recording-material discharge device 6 is provided. The recording-material discharge device 6 is configured to include a discharge roller 43 which is configured by a pair of nip rollers of a driving discharge roller 44 and a driven discharge roller 45 and the above-described discharge stacker 47. In the discharge stacker 47, an extension stacker 48 which is accommodated therein in a nested shape is provided so as to be freely drawn out or received therein.

### Embodiment

Next, the ink jet printer 1 according to the present embodiment, having such a configuration, will be described in detail with reference to the drawings.

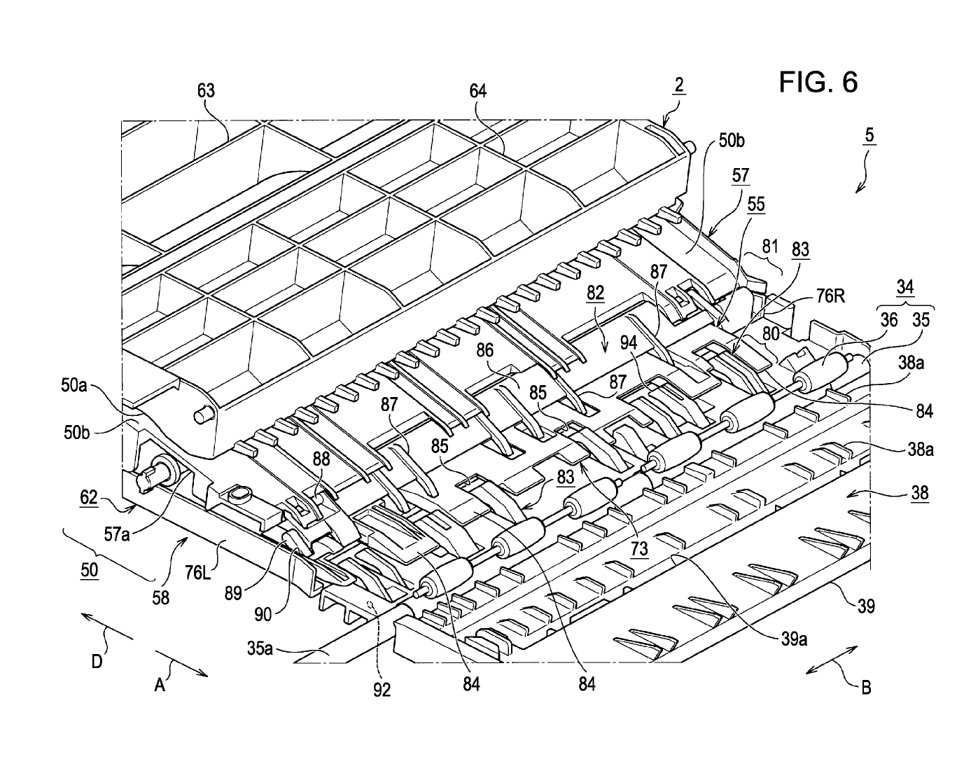

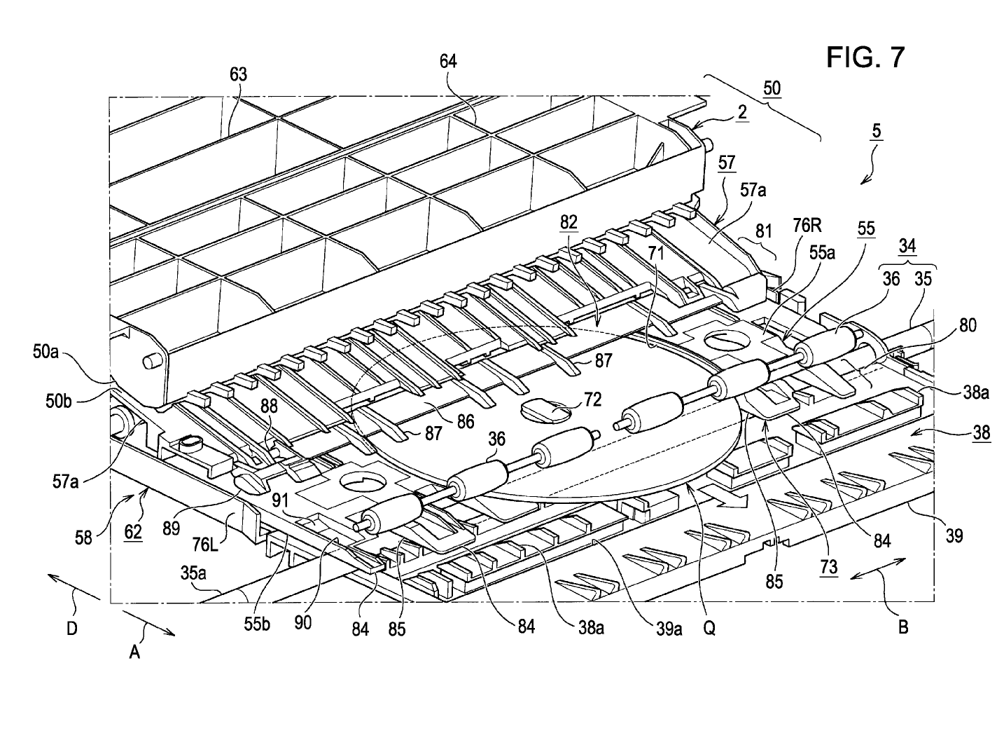

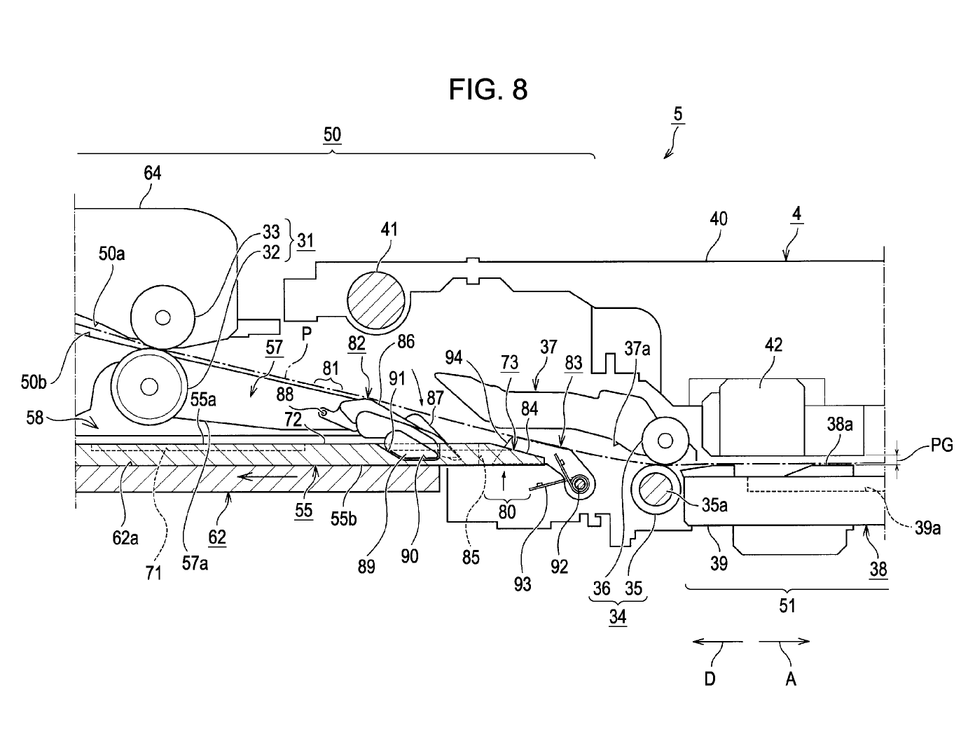

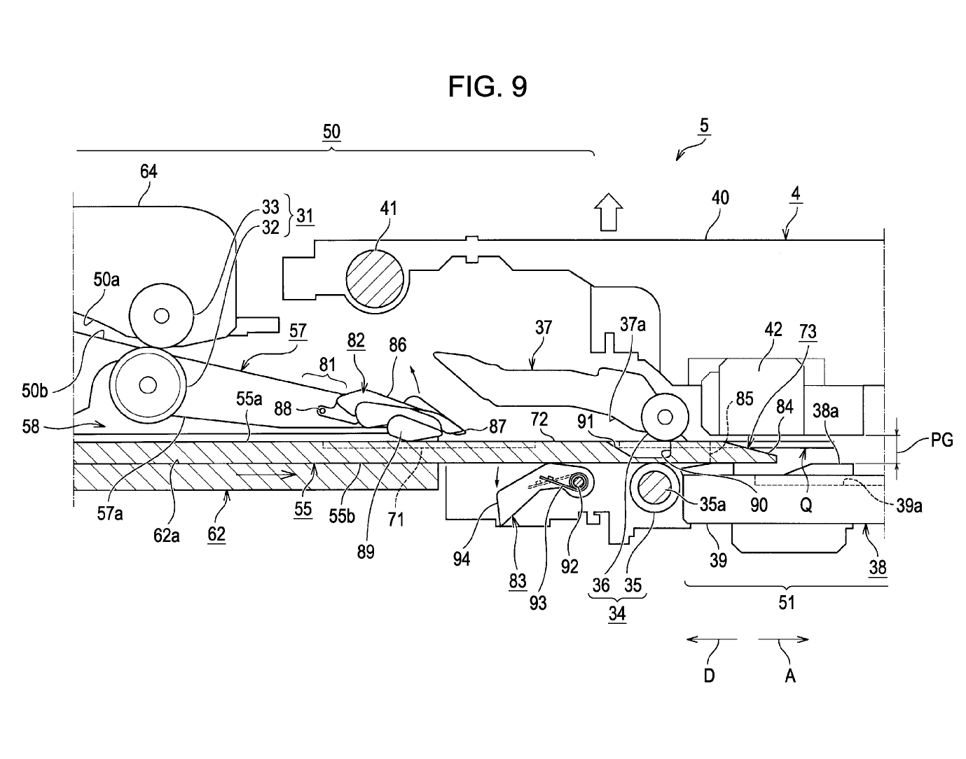

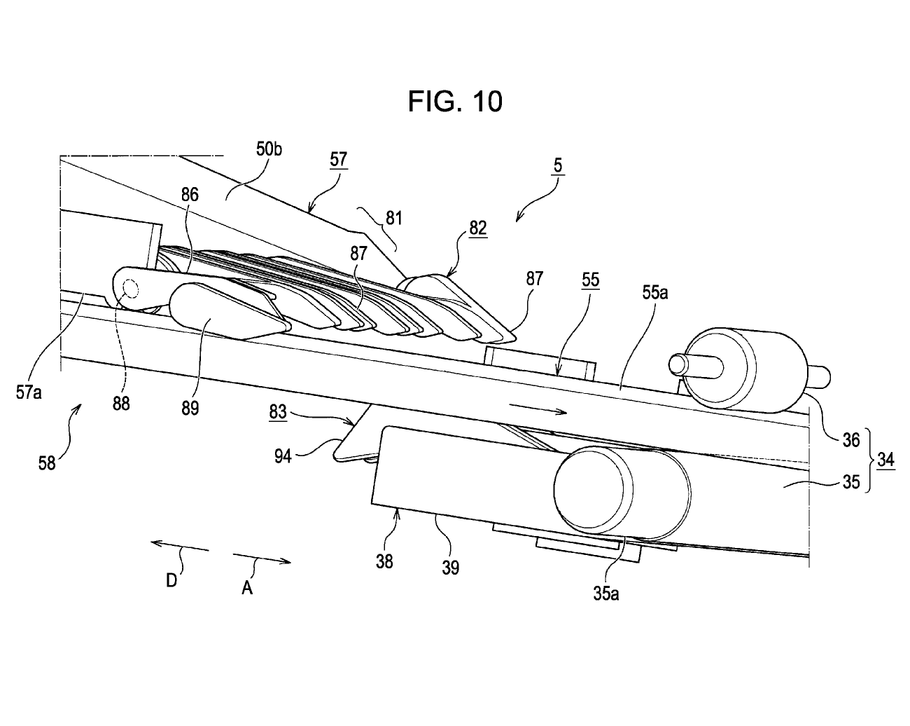

FIG. 6 is a perspective view showing portions of the path forming member from a downstream end thereof to a portion thereof being extended to the transport roller when the holding tray is positioned at the storage position, and FIG. 7 is a perspective view showing portions of the path forming member from a downstream end thereof to a portion thereof being extended to the transport roller when the holding tray is moved from the storage position. FIG. 8 is a side sectional view showing portions of the path forming member from a downstream end thereof to a portion thereof being extended to the transport roller when the holding tray is positioned at a storage position, and FIG. 9 is a side sectional view showing portions of the path forming member from a downstream end thereof to a portion thereof being extended to the transport roller when the holding tray is moved from the storage position. FIG. 10 is a perspective view, on an enlarged scale, of a zone in the vicinity of a levitating projection portion of an upper guide flap when the holding tray is moved from the storage position.

The ink jet printer 1 according to the present embodiment include the path forming member 57 that guides the first recording material P toward the transport roller 34, the holding tray 55 for the second recording material Q which is provided in a lower space 58 of the path forming member 57, an upper transport guide 37 which is a transport guide member provided in the upper vicinity of the downstream position of the path forming member 57 and the holding tray 55, and the transport roller 34 which is provided at the downstream position of the upper transport guide 37, in which at least a part of a front end portion 80 of the holding tray 55 is provided so as to protrude from a downstream end 81 of the path forming member 57 toward the transport roller 34 in a state in which the holding tray 55 is positioned at the storage position 54.

In the present embodiment, the path forming member 57 is provided as a member that forms an inner guide surface 50b of the above-described U-shaped reversal path 50, and an upper guide flap 82 configured to bury the step difference between the path forming member 57 and the holding tray 55 is provided at the downstream end 81 of the path forming member 57. Moreover, lower guide flaps 83 are provided between the holding tray 55 and the transport roller 34 so as to bury the step difference between them.

The U-shaped reversal path 50 is provided by using the rear interior space of the printer body 2. The U-shaped reversal path 50 is configured to include upper housings 63 and 64 which are divided into two parts and positioned on the upper side, the upper transport guide 37 having an inner guide surface 37a, the upper housings 63 and 64 and the upper transport guide 37 being examples of members forming an outer guide surface 50a of the U-shaped reversal path 50, a lower housing 65 which is disposed on the lower side, and the path forming member 57 that forms an inner guide surface 50b of the U-shaped reversal path 50. On the U-shaped reversal path 50, as shown in FIG. 2, a first intermediate conveying roller 25 which is configured by a pair of nip rollers of a driving conveying roller 26 and a driven conveying roller 27, a second guide roller 29 which is configured to be freely rotatable, and a second intermediate conveying roller 31 which is configured by a pair of nip rollers of a driving conveying roller 32 and a driven conveying roller 33 are arranged. By the conveying and guiding operation of these rollers 25, 29 and 31, the soft recording material P supplied to be positioned in the U-shaped reversal path 50 is supplied to the above-described transport roller 34 provided in the vicinity of the downstream position of the U-shaped reversal path 50.

The transport roller 34 is configured by a pair of nip rollers of a driving transport roller 35 which is supported by a roller driving shaft 35a and a driven transport roller 36 which is provided at a front end of the upper transport guide 37 in a freely rotatable state. The position of the driven transport roller 36 in the transport direction A is set to a position which is shifted slightly downstream from the position of the driving transport roller 35 in the transport direction A. By employing the transport roller 34 having such position setting, a front end of the first recording material P supplied thereto is pressed by the platen ribs 38a disposed thereunder, and thus it is possible to prevent the first recording material P from being scratched by the head, thereby achieving improvement in the recording quality.

Moreover, driving force from a not-shown driving motor is transmitted to the roller driving shaft 35a, thereby transporting the first and second recording materials P and Q. In addition, the driving force is transmitted to a transport mechanism 67 via a gear train 66, whereby a movement start operation wherein the second recording material Q starts moving from the storage position 54 and a movement end operation wherein the second recording material Q reaches the storage position 54 can be executed.

Furthermore, a not-shown clutch device is provided in the roller driving shaft 35a, so that by appropriately changing the engagement position of the clutch device, the driving force of the roller driving shaft 35a can be selectively transmitted to the above-described, not-shown ink supply pump, capping device, and automatic gap adjustment mechanism, and the automatic feeding device 3.

The holding tray 55 is a rectangular flat plate-like member having a small depth dimension. At positions of an upper surface 55a of the holding tray 55 located slightly frontward from the central position in the width direction thereof, a concave setting portion 71 for setting the second recording material Q and a convex holding portion 72 for holding the second recording material Q being set at the center thereof are formed. Applicable examples of the second recording material Q which can be set on the holding tray 55 include a variety of optical disks including one that will be developed in the future, such as CD-R, CD-RW, DVD-R, DVD-RW having a diameter of 12 or 8 cm or a blu-ray disk that is attracting attentions as a next-generation optical disk.

In addition, a comb-teeth shaped, uneven surface structure 73 on which convex portions and concave portions are continuously formed in an alternating manner is formed on the front end portion 80 of the holding tray 55 so that the convex portions are configured as guide claws 84 having a sloped surface being downwardly sloped toward the front side and protruding from the downstream end 81 of the path forming member 57 and the concave portions are configured as concave receipt portions 85 that receive therein the lower guide flaps 83. In the vicinity of the corner portions of the rear end portion of the holding tray 55, tongue-like connection pieces 75L and 75R are formed so as to be rotatably connected to front end portions of later-described guide arms 74L and 74R of the extending movement mechanism 59.

Moreover, in a lower space 58 of the path forming member 57, a support member 62 that supports the lower surface of the holding tray 55 when the holding tray 55 is positioned at the storage position 54 is provided. The support member 62 is a rectangular flat plate-like member, and edge guides 76L and 76R are provided at left and right edges of an upper surface 62a of the support member 62 so as to make sliding contact with the left and right edges of the holding tray 55, thereby guiding the movement of the holding tray 55.

The extending movement mechanism 59 is configured to include the folding-type guide arms 74L and 74R which are rotatably connected to the connection pieces 75L and 75R of the holding tray 55, and guide rails 77L and 77R which are configured to engage with guide pins 79 and 79 provided at the proximal end portions of the guide arms 74L and 74R to thereby guide the posture and movement of the guide arms 74L and 74R. The guide pin 79 disposed close to the left guide arm 74L is protruded upward and is configured to engage with the guide rail 77L which has an L shape in plan view and is formed on an inner circumferential surface 57a of the path forming member 57. On the other hand, the guide pin 79 disposed close to the right guide arm 74R is protruded downward and is configured to engage with the guide rail 77R which has an L shape in plan view and is formed on an upper surface 62a of the support member 62.

The movement of the holding tray 55 in the transport direction A and the reverse direction D opposite to the transport direction A is carried out by the above-described auxiliary transport mechanism 67 and the above-described transport roller 34. The transport mechanism 67 carries out the movement wherein the holding tray 55 positioned at the storage position 54 is transferred to the recording execution start position 60 and the movement wherein the holding tray 55 positioned at the recording execution start position 60 is stored at the storage position 54. As an example of the transport mechanism 67, a rack and pinion mechanism can be applied. In the present embodiment, the transport mechanism 67 in which a rack 68 is arranged at the rear right edge portion of the upper surface 55a of the holding tray 55 and a pinion 69 is arranged at a terminating end portion of the gear train 66 transmitting the driving force of the roller driving shaft 35a, respectively, is employed.

The upper guide flap 82 is provided with a rectangular flat plate-like flap body 86 which has a large width dimension approximately the same as that of the holding tray 55 and a small depth dimension, claw-shaped guide ribs 87 which are arranged at appropriate intervals in the width direction so as to extend frontward from an upper surface of the flap body 86 toward a lower edge thereof, a pivot shaft 88 which is provided to a proximal end portion of the flap body 86 and is pivotably connected to the downstream end 81 of the path forming member 57, and a levitating projection portion 89 which is provided at a left edge portion, for example, of the flap body 86 so as to protrude downward. Moreover, the upper guide flap 82 is configured to be in a retractable state wherein the movement of the holding tray 55 is not inhibited. Specifically, the upper guide flap 82 is configured to be pivotable so that a front end portion thereof is moved upward about the pivot shaft 88 when the holding tray 55 is moved from the storage position 54.

The levitating projection portion 89 is configured to make sliding contact with the upper surface 55a of the holding tray 55 when the holding tray 55 is moved from the storage position 54, thereby levitating the front end portions of the guide ribs 87 positioned at the lower end of the upper guide flap 82 from the upper surface 55a of the holding tray 55 to be in a non-contact state. On the other hand, a recessed portion 90 is formed in the vicinity of a left front corner portion of the upper surface 55a of the holding tray 55. Therefore, when the holding tray 55 is positioned at the storage position 54, the levitating projection portion 89 is configured to be received in the recessed portion 90 to be in a non-contact state with the upper surface 55a of the holding tray 55, and the guide ribs 87 of the upper guide flap 82 are in a closed state wherein the step difference between the path forming member 57 and the holding tray 55 is buried. Furthermore, a rear wall surface of the recessed portion 90 is configured as a sloped guide surface 91 which is sloped downward toward the front side, and thus the levitating projection portion 89 can be smoothly advanced and retracted to and from the recessed portion 90.

The lower guide flaps 83 are hook-shaped members having a small width dimension, and a plurality of lower guide flaps is arranged at appropriate intervals over an entire width of the holding tray 55 at positions corresponding to the concave receipt portions 85 of the holding tray 55. The lower guide flaps 83 are protruded backward so that proximal end portions thereof formed with a pivot shaft 92 are positioned on the front side, and are always urged by a torsion coil spring 93 provided in the pivot shaft 92 so that free ends thereof are displaced upward. Moreover, sloped guide surfaces 94 are formed at the free ends of the lower guide flaps 83 so that the free ends of the lower guide flaps 83 are moved downward to be retracted when the lower guide flaps 83 are brought into sliding contact with the lower surface 55b of the holding tray 55. When the holding tray 55 is positioned at the storage position 54, since the lower guide flaps 83 are received in the concave receipt portions 85 of the holding tray 55 as described above, the free ends are displaced frontward by the urging force of the torsion coil spring 93, thereby assuming a transport guide posture wherein the transport of the first recording material P is guided. On the other hand, when the holding tray 55 is moved from the storage position 54, the lower guide flaps 83 make sliding contact with the lower surface 55b of the holding tray 55 as described above, whereby the lower guide flaps 83 assume a retracted posture wherein the free ends are displaced downward.

Next, the operation state of the recording apparatus according to the present embodiment, having such a configuration will be described by dividing the operation into: (1) during storage; (2) at the start of execution of recording operation; (3) at the end of execution of recording operation; and (4) during setting.

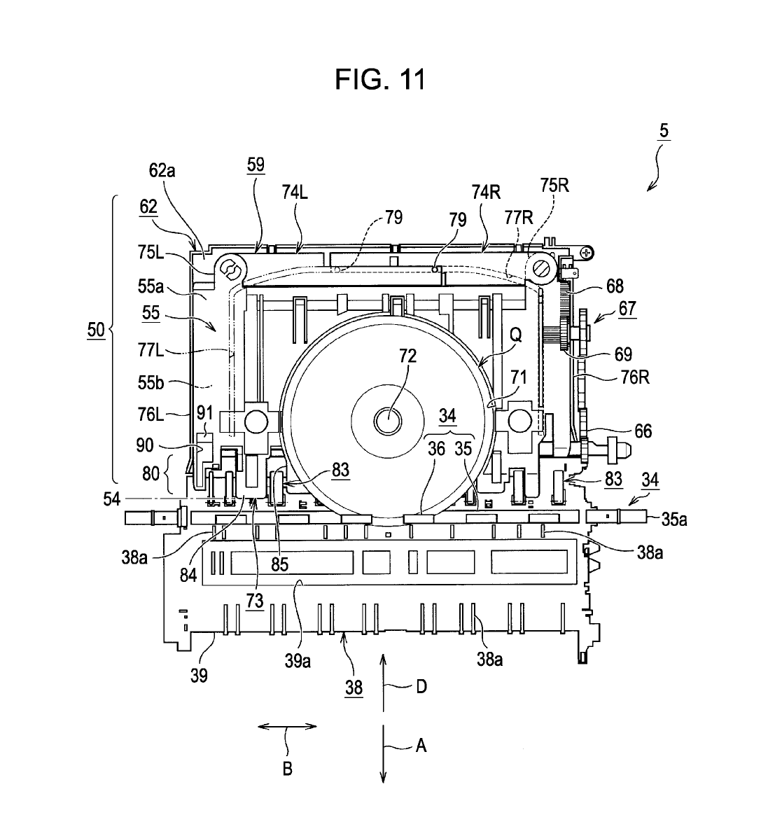

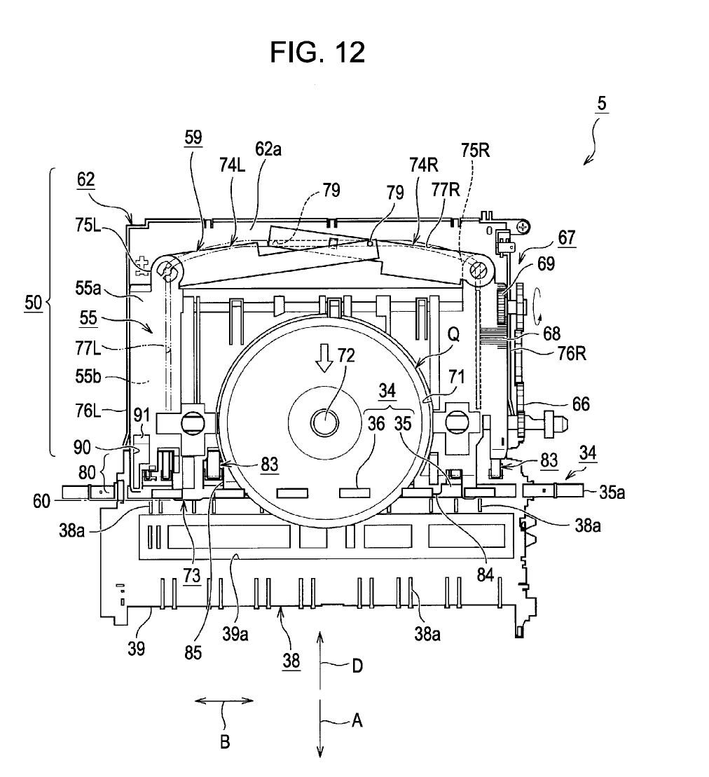

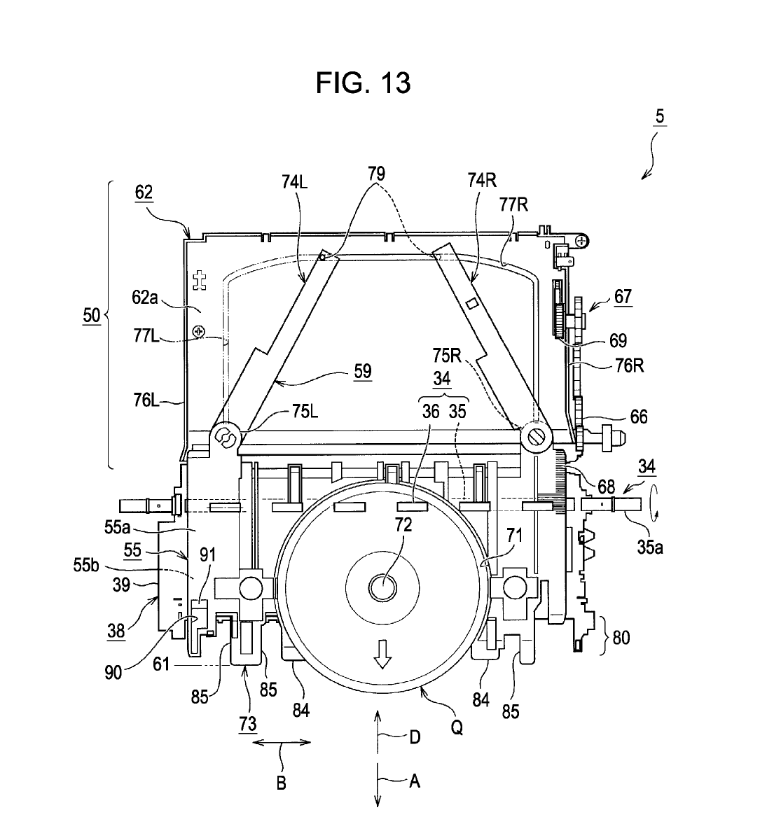

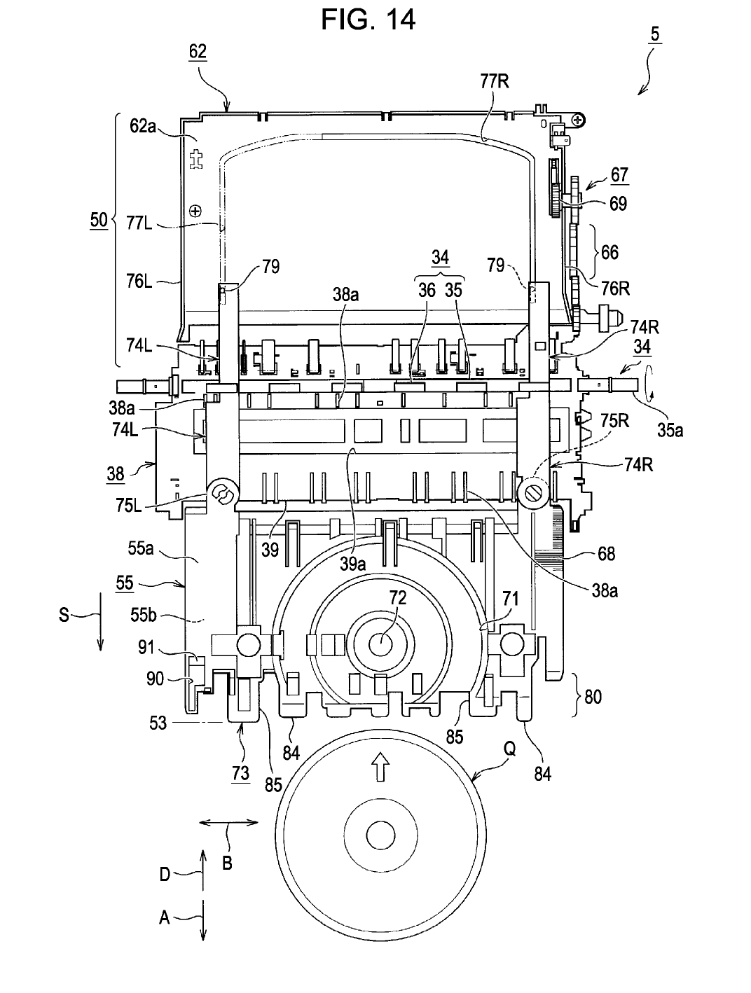

FIG. 11 is a top plan view of the recording apparatus when the holding tray is positioned at the storage position, and FIG. 12 is a top plan view when the holding tray is positioned at the recording execution start position. FIG. 13 is a top plan view when the holding tray is positioned at the recording execution ending position, and FIG. 14 is a top plan view when the holding tray is positioned at the set position.

### (1) During Storage (FIGS. 2, 6, 8, and 11)

When the holding tray 55 is positioned at the storage position 54, the holding tray 55 is stored within the U-shaped reversal path 50 in a state in which the lower surface 55b is supported by the support member 62 in the lower space 58 of the path forming member 57. When the holding tray 55 is positioned at the storage position 54, as described above, since the levitating projection portion 89 is in a state of being received in the recessed portion 90, the front end portions of the guide ribs 87 of the lower edge of the upper guide flap 82 are displaced downward, thereby assuming a transport guide posture wherein the step difference between the path forming member 57 and the holding tray 55 is buried so that the first recording material P can be transported. Moreover, as described above, since the lower guide flaps 83 are also in a state of being received in the concave receipt portions 85, the free ends of the lower guide flaps 83 assume a transport guide posture wherein they protrude outward so that the first recording material P can be transported.

When a recording operation is performed on the first recording material P, the automatic feeding device 3 is operated so that only the uppermost one of the first recording materials P accommodated in the feed cassette 11 is supplied to the U-shaped reversal path 50. In the U-shaped reversal path 50, a conveying force is applied to the first recording material P by the first intermediate conveying roller 25 and the second intermediate conveying roller 31 and is guided to the transport roller 34 by the second guide roller 29, the outer guide surface 50a and the inner guide surface 50b of the U-shaped reversal path 50, and the inner guide surface 37a of the upper transport guide 37. Moreover, the first recording material P is transported to the recording position 51 by the pinching and transporting action of the transport roller 34, whereby a recording operation is executed on an upper surface of the recording material by the recording execution device 4.

When a recording operation is subsequently executed on a rear surface of the first recording material P, in order to guide the first recording material P to the reverse path, the first recording material P having data or images recorded on the upper surface thereof is moved in the reverse direction D. At this time, since the step difference between the path forming member 57 and the holding tray 55 is buried by the upper guide flap 82 and the step difference between the holding tray 55 and the transport roller 34 is buried by the lower guide flaps 83, respectively, the first recording material P can be smoothly transported in the reverse direction D without being caught at the step difference.

### (2) At the Start of Execution of Recording Operation (FIGS. 3, 7, 9, 10, and 12)

When the driving force of the roller driving shaft 35a is transmitted to the rack 68 of the holding tray 55 positioned at the storage position 54 via the gear train 66 and the pinion 69, the holding tray 55 starts moving forward. The levitating projection portion 89 is guided to the sloped guide surface 91 of the recessed portion 90 to be retracted from the recessed portion 90 in accordance with the forward movement of the holding tray 55, thereby making contact with the upper surface 55a of the holding tray 55. Moreover, the upper guide flap 82 is pivoted at a predetermined angle about the pivot shaft in a direction where the front end portions of the guide ribs 87 move closer to the upper transport guide 37 disposed thereabove in accordance with the upward movement of the levitating projection portion 89, whereby the front end portions of the guide ribs 87 are in a non-contact state of being levitated from the upper surface 55a of the holding tray 55, as shown in FIG. 10.

On the other hand, the lower guide flaps 83 are in a state of being in abutting contact with the lower surface 55b of the holding tray 55 with the sloped guide surfaces 94 formed at the free ends thereof making abutting contact with the rear end surfaces of the concave receipt portions 85 of the holding tray 55 to be moved downward against the urging force of the torsion coil spring 93. Therefore, the holding tray 55 is able to smoothly transport the second recording material Q in the transport direction A and the reverse direction D without receiving large transport resistance from the upper guide flap 82 and the lower guide flaps 83.

When the front end portion of the holding tray 55 reaches the nip point of the transport roller 34, the transmission of the driving force from the transport mechanism 67 stops, and the holding tray 55 reaches the recording execution start position 60 wherein it receives the driving force from the transport roller 34. Since the holding tray 55 is used when a recording operation is performed on the second recording material Q, the gap PG between the recording head 42 and the platen 38 is enlarged upward by operating a not-shown automatic gap adjustment device so as to be set to a gap PG for the second recording material Q.

### (3) At the End of Execution of Recording Operation (FIGS. 4 and 13)

The holding tray 55 and the second recording material Q guided to the recording execution start position 60 is transported toward the transport direction A by the pinching and transporting action of the transport roller 34. At the same time, ink of each color is ejected downward from the recording head 42 over an entire width of the recording surface of the second recording material Q by the reciprocating movement of the carriage 40 reciprocating in the width direction B, whereby a recording operation is executed on the recording material. When the recording operation is executed on the recording surface of the second recording material Q, the holding tray 55 arrives at the recording execution ending position 61 shown in FIGS. 4 and 13, and a discharge operation is then performed by the discharge roller 43.

### (4) During Setting (FIGS. 5 and 14)

When the second recording material Q is set on the holding tray 55 or when the second recording material Q having data or images recorded thereon is removed from the holding tray 55, the holding tray 55 is positioned at the set position 53 wherein the holding tray 55 is drawn out to the frontmost position as shown in FIGS. 5 and 14. The movement of the holding tray 55 between the recording execution ending position 61 and the set position 53 is carried out by causing the left and right guide arms 74L and 74R to be pinched by the transport roller 34 as shown in the drawings. In the course of the movement of the holding tray 55 between the storage position 54 and the recording execution start position 60, the movement of the holding tray 55 between the recording execution start position 60 and the recording execution ending position 61, and the movement of the holding tray 55 between the recording execution ending position 61 and the set position 53, the guide pins 79 and 79 provided at the proximal end portions of the guide arms 74L and 74R are always in a state of being engaged with the guide rails 77L and 77R. Moreover, the postures of the guide arms 74L and 74R are continuously changed from the folded state shown in FIGS. 2 and 11 to the extended state shown in FIGS. 5 and 14.

The operation state of the holding tray 55 according to the present embodiment during movement from the set position 53 to the storage position 54 is opposite to the above-described operation state, and the details thereof are the same as those of the above.

### Other Embodiment

Although the recording apparatus 1 according to the present embodiment basically has the above-described configuration, a partial configuration may be modified or omitted within the range without departing from the spirit of the invention. For example, the transport path for the first recording material P in the recording apparatus of the invention is not limited to the U-shaped reversal path 50 that reverses the first recording material P supplied from the front surface 2a of the printer body 2 in a U shape and discharges the first recording material P from the front surface 2a of the printer body 2. Therefore, a transport path for the first recording material P which transports the first recording material P supplied from a feed tray provided at an upper rear portion of the printer body 2 toward the front surface 2a of the printer body 2 may be employed. In a type of recording apparatus that executes a recording operation on only the upper surface of the first recording material P, the upper guide flap 82 and the lower guide flaps 83 may be omitted.

What is claimed is:

1. A recording apparatus comprising:
a transport roller that transports recording materials;
a holding tray for setting a first recording material, which is configured to be advanced and retracted between a first position wherein the first recording material can be transported by the transport roller and a second position wherein the holding tray is retracted from the first position; and
a path forming member for guiding a second recording material from above or below the second position to a position wherein the recording material can be transported by the transport roller,
wherein a front end portion of the holding tray being retracted to the second position protrudes to a position located between a guide path formed by the path forming member and the transport roller.

2. The recording apparatus according to claim 1, wherein a pivotable upper guide flap configured to bury a step difference between the path forming member and the holding tray is provided at a downstream end of the path forming member in a retractable state wherein the movement of the holding tray is not inhibited.

3. The recording apparatus according to claim 2, wherein pivotable lower guide flaps which are urged upwardly are provided between the holding tray and the transport roller so as to bury a step difference between them in a retractable state wherein the movement of the holding tray is not inhibited.

4. The recording apparatus according to claim 3, wherein a comb-teeth shaped uneven surface structure on which convex portions and concave portions are continuously formed in an alternating manner is formed on the front end portion of the holding tray, in which the convex portions are configured as guide claws which protrude from the downstream end of the path forming member and the concave portions are configured as concave receipt portions which receive therein the lower guide flaps.

5. The recording apparatus according to claim 2, wherein a levitating projection portion is formed in a part of the upper guide flap so as to make sliding contact with an upper surface of the holding tray when the holding tray is moved from a storage position, thereby levitating the lower edge of the upper guide flap from the upper surface of the holding tray to be in a non-contact state.

6. The recording apparatus according to claim 5, wherein when the holding tray is positioned at the storage position, the levitating projection portion is received in a recessed portion, which is formed on the upper surface of the holding tray, to be in a non-contact state with the upper surface of the holding tray, and the lower edge of the upper guide flap is in a closed state wherein the step difference between the path forming member and the holding tray is buried.
